(19) United States
(12) Patent Application Publication
(10) Pub. No.: US 2026/0103916 A1
(43) Pub. Date: Apr. 16, 2026

(54) ELECTRONIC LOCK WITH MONITORING AND PROTECTION CIRCUITRY

(71) Applicant: ASSA ABLOY Americas Residential Inc., New Haven, CT (US)

(72) Inventor: Kevin Pasma, Lake Forest, CA (US)

(21) Appl. No.: 19/357,502

(22) Filed: Oct. 14, 2025

Related U.S. Application Data
(60) Provisional application No. 63/707,065, filed on Oct. 14, 2024.

(51) Int. Cl. E05B 47/00

(52) U.S. Cl. CPC E05B 47/0001; E05B 2047/0026; E05B 2047/0054; E05B 2047/0058; E05B 2047/0072; E05B 2047/0097

(57) ABSTRACT

An electronic lock with monitoring and protection circuitry is provided. In example embodiments, an electronic lock may include a battery status monitoring circuit configured to determine at least one of a battery life or a battery health of a battery of the electronic lock. In some embodiments, an electronic lock may include a motor runaway protection circuit configured to trigger at least a partial reset of the electronic lock when a motor of the electronic lock enters a runaway state. In additional example embodiments, an electronic lock may include a back-drive protection circuit configured to protect the electronic lock against a back-drive voltage generated by a motor of the electronic lock during rotation of a manual turn piece.

### CROSS-REFERENCE TO RELATED APPLICATIONS

This application claims priority to U.S. Provisional Patent Application No. 63/707,065 filed October 14, 2024, the disclosure of which is incorporated herein by reference in its entirety.

### BACKGROUND

Electronic locks require a power supply to provide power to the electrical components of the locks. In many cases, one or more batteries are used as the power supply for an electronic lock. Because the battery provides power for the electronic lock, it is critical to adequately monitor a status of the battery so that a user can know when to replace or recharge the battery. Failure to do so can result in the battery dying, which in turn may render the electronic lock inoperative.

Additionally, electronic locks may experience other electrical conditions that may interrupt or affect operability of the lock, including unexpected electrical signaling issues or voltage spikes which may cause damage to electrical components. Existing solutions often leave such devices exposed to harmful electrical conditions that could have a negative impact on the battery or circuit operation, and therefore affect operation of the electronic lock as a whole.

### SUMMARY

In general terms, this disclosure is directed to an electronic lock with monitoring and protection circuitry. In some embodiments, and by non-limiting example, an electronic lock may include one or more of a battery status monitoring circuit, a runaway motor protection circuit, and a motor back-drive protection circuit. These circuits may allow for monitoring of status of a battery of the electronic lock (e.g., battery life and battery health) and protect the circuitry of the electronic lock from harmful electrical conditions (e.g., a runaway motor and motor back-drive voltages).

In an aspect, an electronic lock is provided. The electronic lock comprises a battery, a battery status monitoring circuit including a battery health load, a processing unit, and a memory device. The memory device stores instructions that, when executed by the processing unit, cause the electronic lock to connect the battery to the battery health load, determine a battery health voltage of the battery, and determine a battery health of the battery based on the battery health voltage. The battery health load simulates a load experienced by the battery during operation of the electronic lock. The battery health voltage is a voltage supplied by the battery while the battery is connected to the battery health load.

In another aspect, an electronic lock is provided. The electronic lock includes a latch assembly including a bolt movable between a locked position and an unlocked position, a motor configured to move the bolt from the locked position to the unlocked position or from the unlocked position to the locked position, a processing unit, and a motor runaway protection circuit. The motor runaway protection circuit is configured to measure a voltage representative of a current draw of the motor when the motor is active, determine whether the measured voltage exceeds a predetermined runaway voltage threshold, and in response to determining that the measured voltage exceeds the predetermined runaway voltage threshold, trigger at least a partial reset of the electronic lock. The motor is activated by the processing unit. The at least partial reset of the electronic lock causes the motor to deactivate.

In a further aspect, an electronic lock is provided. The electronic lock comprises a latch assembly including a bolt movable between a locked position and an unlocked position, a motor configured to move the bolt from the locked position to the unlocked position or from the unlocked position to the locked position, a turn piece mechanically connected to the latch assembly, wherein rotation of the turn piece moves the bolt from the locked position to the unlocked position or from the unlocked position to the locked position, and a back-drive protection circuit. The back-drive protection circuit is configured to measure a voltage generated by the motor during rotation of the turn piece, determine whether the voltage exceeds a predetermined back-drive voltage threshold, and in response to the voltage exceeding the predetermined back-drive voltage threshold, clamp the voltage.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

FIG. 1 illustrates a side view of a portion of an electronic lock installed at a door.

FIG. 2 illustrates a rear perspective view of a portion of the electronic lock shown in FIG. 1.

FIG. 3 illustrates a front perspective of a portion of the electronic lock shown in FIG. 1.

FIG. 4 illustrates a schematic representation of the electronic lock shown in FIG. 1.

FIG. 5 illustrates an environment in which aspects of the present disclosure may be implemented.

FIG. 6 illustrates a schematic representation of a mobile device seen in the environment shown in FIG. 5.

FIG. 7 illustrates a schematic representation of a battery status monitoring circuit.

FIG. 8A illustrates a first example circuit diagram of a battery status monitoring circuit.

FIG. 8B illustrates a second example circuit diagram of a battery status monitoring circuit.

FIG. 9 illustrates a flowchart of an example method for monitoring a battery life and a battery health of a battery in an electronic lock.

FIG. 10 illustrates a schematic diagram of a motor runaway protection circuit.

FIG. 11 illustrates a circuit diagram of a motor runaway protection circuit.

FIG. 12 illustrates a flowchart of an example method for protecting against a runaway motor in an electronic lock.

FIG. 13 illustrates a schematic diagram of a motor back-drive protection circuit.

FIG. 14 illustrates a circuit diagram of a motor back-drive protection circuit.

FIG. 15 illustrates a flowchart of an example method for protecting against motor back-drive.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

As briefly described above, the present disclosure is directed to an electronic lock with monitoring and protection circuitry. In example aspects, an electronic lock includes one or more circuits for monitoring a status of a battery in the electronic lock and protecting electrical components of the lock from harmful electrical conditions.

In some aspects, the electronic lock may include a battery status monitoring circuit. In embodiments, the battery status monitoring circuit may determine a battery life of the battery, a battery health of the battery, or both. For example, the battery status monitoring circuit may selectively connect the battery to one or more of a battery life load and a battery health load, and a voltage of the battery may be measured while the battery is connected to the loads. By monitoring the battery life and battery health of the battery, a user can properly determine when it is appropriate to replace or recharge the battery.

In additional aspects, the electronic lock may include a motor runaway protection circuit. In embodiments, the motor runaway protection circuit may protect the battery (and other electrical and mechanical components of the electronic lock) from a motor operating in a runaway state. For example, an error may cause an electronic clutch to fail to disengage a motor, allowing the motor to continue to operate even if a bolt is fully extended or retracted, or otherwise in an error state. While the motor is operating in the runaway state, the motor may draw increasing power from the battery as the motor outputs increasing force to attempt to further extend/retract the bolt. To protect against the motor operating in the runaway state, the motor runaway protection circuit may monitor the voltage supplied to the motor and trigger a reset when the voltage reaches a predetermined threshold.

In further aspects, the electronic lock may include a motor back-drive protection circuit. In some embodiments, rotation of a manual turn piece to extend or retract a bolt may cause a motor of the electronic lock to generate a voltage, which may be harmful to the battery or other components of the electronic lock. To protect against the back-drive voltage, the motor back-drive protection circuit may monitor a voltage of the motor and clamp the voltage when it reaches a predetermined threshold.

The term “lock” or “lockset” is broadly intended to include any type of lock, including, but not limited to, deadbolts, knob locks, lever handle locks, mortise locks, and slide locks, whether mechanical, electrical, or electro-mechanical locks. The locking points may have various mounting configurations and/or locations, including, but not limited to, mortised within the doorframe, mounted externally to the doorframe or support structure, and/or affixed directly to the door.

Although this disclosure describes these features as implemented on an electronic deadbolt lock for purposes of example, these features are applicable to any type of lockset, including but not limited to, deadbolts, knobset locks, handleset locks, etc. Still further, example aspects of the present application can be applied to other types of IoT devices for which security is an issue, e.g., wireless/interconnected home devices that store user data.

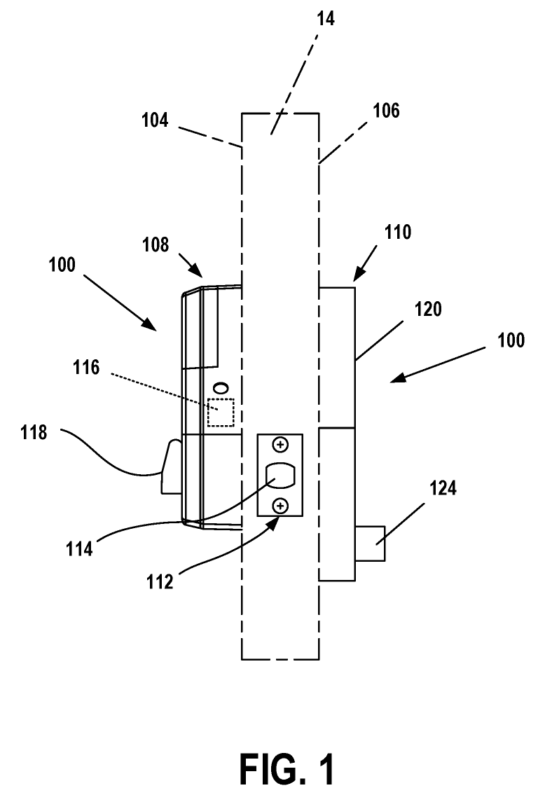

FIGS. 1-3 illustrate an electronic lock 100 as installed at a door 14 according to one example of the present disclosure in which battery monitoring and protection may be implemented. In this example, the door 14 has an interior side 104 and an exterior side 106. The electronic lock 100 includes an interior assembly 108, an exterior assembly 110, and a latch assembly 112. The latch assembly 112 is shown to include a bolt 114 that is movable between an extended position (locked) and a retracted position (unlocked, shown in FIGS. 1-3). Specifically, the bolt 114 is configured to slide longitudinally and, when the bolt 114 is retracted, the door 14 is in an unlocked state. When the bolt 114 is extended, the bolt 114 protrudes from the door 14 into a doorjamb (not shown) to place the door in a locked state.

In some examples, the interior assembly 108 is mounted to the interior side 104 of the door 14, and the exterior assembly 110 is mounted to the exterior side 106 of the door 14. The latch assembly 112 is typically at least partially mounted in a bore formed in the door 14. The term “outside” is broadly used to mean an area outside the door 14 and “inside” is broadly used to denote an area inside the door 14. With an exterior entry door, for example, the exterior assembly 110 may be mounted outside a building, while the interior assembly 108 may be mounted inside a building. With an interior door, the exterior assembly 110 may be mounted inside a building, but outside a room secured by the electronic lock 100, and the interior assembly 108 may be mounted inside the secured room. The electronic lock 100 is applicable to both interior and exterior doors.

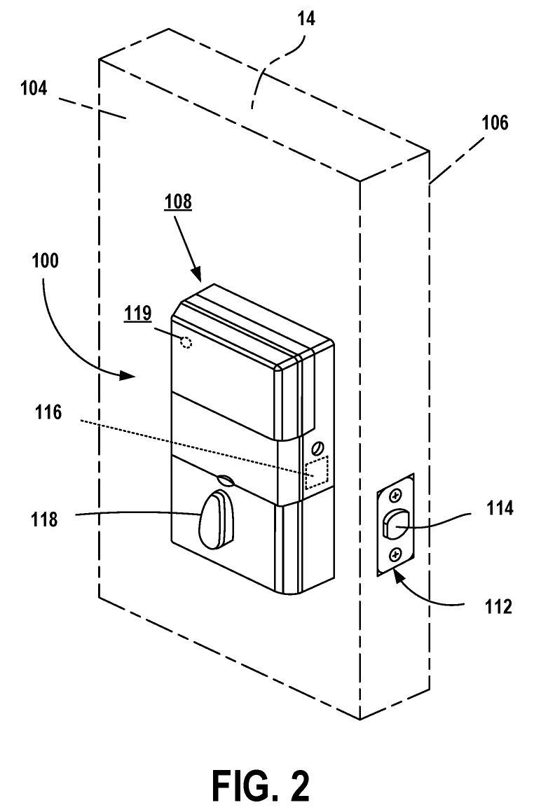

Referring to FIG. 2, the interior assembly 108 can include a processing unit 116 (shown schematically) containing electronic circuitry for the electronic lock 100, which may include battery monitoring and protection circuitry as described further herein. In some examples, the interior assembly 108 includes a manual turn piece 118 that can be used on the interior side 104 of door 14 to move the bolt 114 between the extended and retracted positions. The processing unit 116 is operable to execute a plurality of software instructions (i.e., firmware) that, when executed by the processing unit 116, cause the electronic lock 100 to implement the methods and otherwise operate and have functionality as described herein. The processing unit 116 may comprise a device commonly referred to as a processor, e.g., a central processing unit (CPU), digital signal processor (DSP), or other similar device, and may be embodied as a standalone unit or as a device shared with components of the electronic lock 100. The processing unit 116 may include memory communicatively interfaced to the processor, for storing the software instructions. Alternatively, the electronic lock 100 may further comprise a separate memory device for storing the software instructions that is electrically connected to the processing unit 116 for the bi-directional communication of the instructions, data, and signals therebetween.

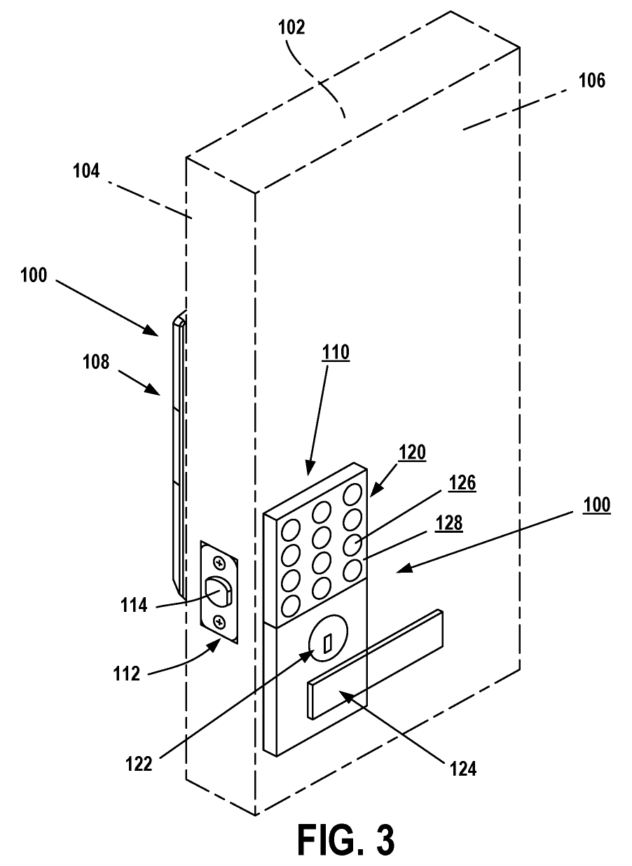

Referring to FIG. 3, the exterior assembly 110 can include exterior circuitry communicatively and electrically connected to the processing unit 116. For example, the exterior assembly 110 can include a keypad 120 for receiving a user input and/or a keyway 122 for receiving a key (not shown). The exterior side 106 of the door 14 can also include a handle 124. In some examples, the exterior assembly 110 includes the keypad 120 and not the keyway 122. In some examples, the exterior assembly 110 includes the keyway 122 and the keypad 120. When a valid key is inserted into the keyway 122, the valid key can move the bolt 114 between the extended and retracted positions. When a user inputs a valid actuation passcode into the keypad 120, the bolt 114 is moved between the extended and retracted positions. In some examples, the exterior assembly 110 is electrically connected to the interior assembly 108. Specifically, the keypad 120 is electrically connected to the interior assembly 108, specifically to the processing unit 116, by, for example, an electrical cable (not shown) that passes through the door 14. When the user inputs a valid actuation passcode via the keypad 120 that is recognized by the processing unit 116, an electrical motor is energized to retract the bolt 114 of the latch assembly 112, thus permitting the door 14 to be opened from a closed position. Still further, an electrical connection between the exterior assembly 110 and the interior assembly 108 allows the processing unit 116 to communicate with other features included in the exterior assembly 110, as noted below.

The keypad 120 can be any of a variety of different types of keypads. The keypad 120 can be one of a numeric keypad, an alpha keypad, and/or an alphanumeric keypad. The keypad 120 can have a plurality of characters displayed thereon, with each character being associated with a predefined keypad region 126. In an example, the keypad regions 126 include a plurality of buttons that can be mechanically actuated by the user (e.g., physically pressed). In some examples, the keypad regions 126 are defined in a touch interface 128, such as a touch screen or a touch keypad, for receiving a user input. The touch interface 128 is configured to detect a user's “press of a button” by contact without the need for pressure or mechanical actuation. An example of the touch interface is described in U.S. Patent No. 9,424,700 for an “ELECTRONIC LOCK HAVING USAGE AND WEAR LEVELING OF A TOUCH SURFACE THROUGH RANDOMIZED CODE ENTRY,” which is hereby incorporated by reference in its entirety.

In alternative embodiments, one or more other types of user interface devices can be incorporated into the electronic lock 100. For example, in example implementations, the exterior assembly 110 can include a biometric interface (e.g., a fingerprint sensor, retina scanner, or camera including facial recognition), or an audio interface by which voice recognition could be used to actuate the lock. Still further, other touch interfaces may be implemented, e.g., where a single touch may be used to actuate the lock rather than requiring entry of a specified actuation passcode.

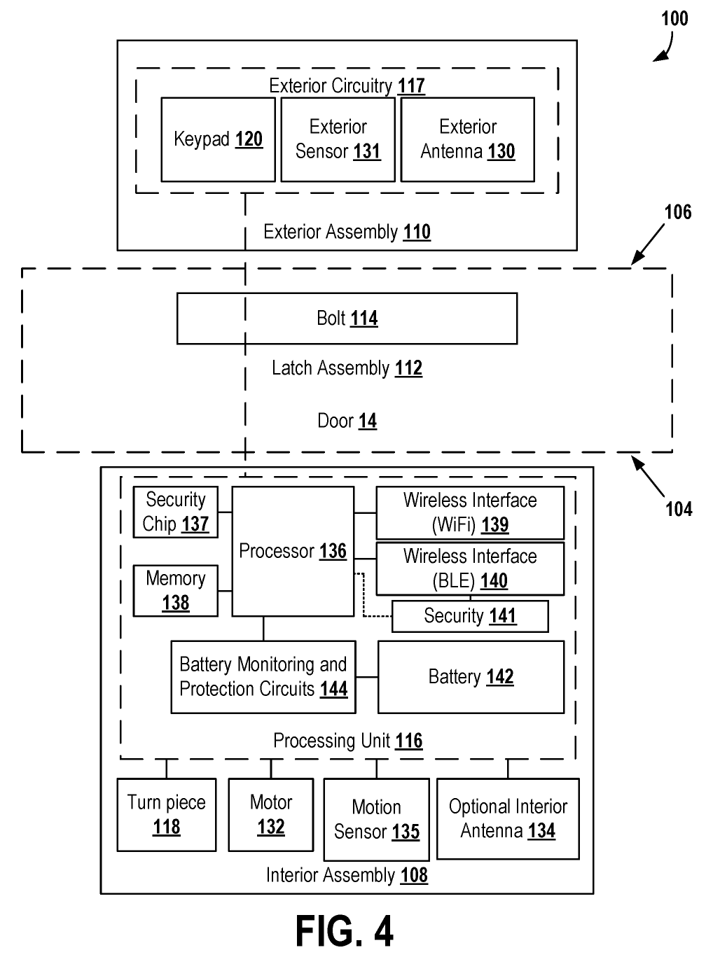

FIG. 4 shows a schematic representation of the electronic lock 100 mounted to the door 14. The interior assembly 108, the exterior assembly 110, and the latch assembly 112 are shown.

The exterior assembly 110 is shown to include the keypad 120 and an optional exterior antenna 130 usable for communication with a remote device. In some examples, the exterior antenna 130 includes an antenna array of a plurality of antennas useable to detect or determine position of a remote device in wireless communication with the electronic lock 100. In addition, the exterior assembly 110 can include one or more sensors 131, such as a camera, proximity sensor, or other mechanism by which conditions exterior to the door 14 can be sensed.

The exterior antenna 130 is capable of being used in conjunction with an interior antenna 134, such that the processing unit 116 can determine where a mobile device is located. Only a mobile device that is paired with the electronic lock 100 and determined to be located on the exterior of the door 14 is able to actuate (unlock or lock) the door 14. This prevents unauthorized users from being located exterior to the door 14 of the electronic lock 100 and taking advantage of an authorized mobile device that may be located on the interior of the door 14, even though that authorized mobile device is not being used to actuate the door 14. However, such a feature is not required, but can add additional security. In alternative arrangements, the electronic lock 100 is only actuatable from either the keypad 120 (via entry of a valid actuation passcode) or from an application installed on the mobile device. In such arrangements, because touch alone at the exterior of the door 14 cannot actuate the lock, the exterior antenna 130 may be excluded entirely.

As described above, the interior assembly 108 includes the processing unit 116. The interior assembly 108 can also include a motor 132 and an optional interior antenna 134.

As shown, the processing unit 116 includes at least one processor 136 communicatively connected to a security chip 137, a memory 138, various wireless communication interfaces (e.g., including a Wi-Fi interface 139 and/or a Bluetooth interface 140), and a battery 142. The processing unit 116 may further include battery monitoring and protection circuits 144, as described further herein. The processing unit 116 is located within the interior assembly 108 and is capable of operating the electronic lock 100, e.g., by actuating a motor 132 to actuate the bolt 114.

In some examples, the processor 136 can process signals received from a variety of devices to determine whether the electronic lock 100 should be actuated. Such processing can be based on a set of preprogramed instructions (i.e., firmware) stored in the memory 138. In certain embodiments, the processing unit 116 can include a plurality of processors 136, including one or more general purpose or specific purpose instruction processors. In some examples, the processing unit 116 is configured to capture a keypad input event from a user and store the keypad input event in the memory 138. In other examples, the processor 136 receives a signal from the exterior antenna 130, the interior antenna 134, or a motion sensor 135 (e.g., a vibration sensor, gyroscope, accelerometer, motion/position sensor, or combination thereof) and can validate received signals in order to actuate the lock 100. In still other examples, the processor 136 receives signals from the Bluetooth interface 140 to determine whether to actuate the electronic lock 100.

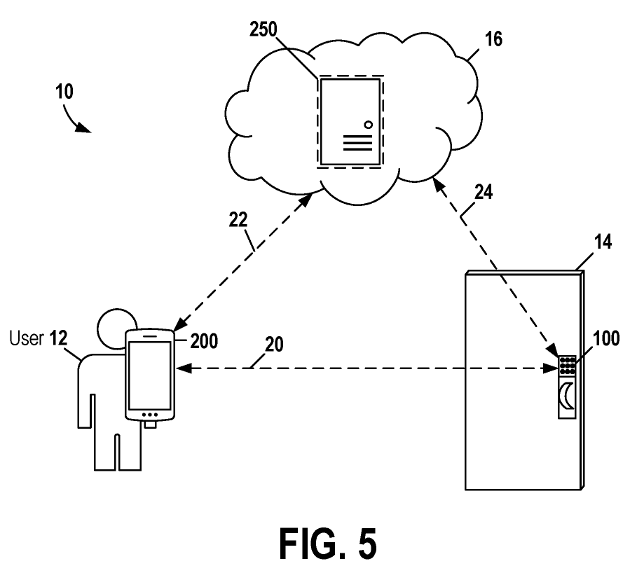

In some embodiments, the processing unit 116 includes a security chip 137 that is communicatively interconnected with one or more instances of processor 136. The security chip 137 can, for example, generate and store cryptographic information usable to generate a certificate usable to validate the electronic lock 100 with a remote system, such as a server 250 or mobile device 200 shown in FIG. 5. In certain embodiments, the security chip 137 includes a one-time write function in which a portion of memory of the security chip 137 can be written only once, and then locked. Such memory can be used, for example, to store cryptographic information derived from characteristics of the electronic lock 100, or its communication channels with server 250 or one or more mobile devices 200. Accordingly, once written, such cryptographic information can be used in a certificate generation process which ensures that, if any of the characteristics reflected in the cryptographic information are changed, the certificate that is generated by the security chip 137 would become invalid, and thereby render the electronic lock 100 unable to perform various functions, such as communicate with the server 250 or mobile device 200, or operate at all, in some cases.

In some embodiments, the security chip 137 may be configured to generate a pairing passcode that, when entered using the keypad 120 of the electronic lock 100, triggers a BLE pairing mode of the electronic lock 100 that enables the electronic lock 100 to pair with a proximate mobile device (e.g., mobile device 200 on which an electronic lock application associated with the electronic lock 100 is operating). In some examples, the pairing passcode is provided to a user 12 upon initial setup/activation of the electronic lock 100 (e.g., via an electronic lock application associated with the electronic lock 100 operating on the mobile device 200). In some examples, the pairing passcode is a random value. In some examples, the user 12 may be enabled to change the pairing passcode by setting their own code or by requesting a random value to be generated by the electronic lock application operating on the mobile device 200. In some examples, the length of the pairing passcode is variable. According to an aspect, for increased security, the pairing passcode may be a limited-use passcode. For example, the pairing passcode may be limited to a single use or may be active for a preset or user-selected time duration. In further examples, a digit of the pairing passcode may correspond to a setting that may instruct the electronic lock 100 to perform one or more of: disable the pairing passcode after it has been used; keep the pairing passcode enabled after it has been used; or reset the pairing passcode to a new random value after it has been used.

The memory 138 can include any of a variety of memory devices, such as using various types of computer-readable or computer storage media. A computer storage medium or computer-readable medium may be any medium that can contain or store the program for use by or in connection with the instruction execution system, apparatus, or device. By way of example, computer storage media may include dynamic random access memory (DRAM) or variants thereof, solid state memory, read-only memory (ROM), electrically erasable programmable ROM, and other types of devices and/or articles of manufacture that store data. Computer storage media generally includes at least one or more tangible media or devices. Computer storage media can, in some examples, include embodiments including entirely non-transitory components.

As noted above, the processing unit 116 can include one or more wireless interfaces, such as Wi-Fi interface 139 and/or a Bluetooth interface 140. Other RF circuits can be included as well. In the example shown, the interfaces 139, 140 are capable of communication using at least one wireless communication protocol. In some examples, the processing unit 116 can communicate with a remote device via the Wi-Fi interface 139, or a local device via the Bluetooth interface 140. In some examples, the processing unit 116 can communicate with one or both of the mobile device 200 and server 250 via the Wi-Fi interface, and can communicate with the mobile device 200 when the mobile device 200 is in proximity to the electronic lock 100 via the Bluetooth interface 140. In some embodiments, the processing unit 116 is configured to communicate with the mobile device 200 via the Bluetooth interface 140, and communications between the mobile device 200 and electronic lock 100 when the mobile device 200 is out of range of Bluetooth wireless signals can be relayed via the server 250, e.g., via the Wi-Fi interface 139.

Of course, in alternative embodiments, other wireless protocols could be implemented as well, via one or more additional wireless interfaces. In some examples, the electronic lock 100 can wirelessly communicate with external devices through a desired wireless communications protocol. In some examples, an external device can wirelessly control the operation of the electronic lock 100, such as operation of the bolt 114. The electronic lock 100 can utilize wireless protocols including, but not limited to, the IEEE 802.11 standard (Wi-Fi®), the IEEE 802.15.4 standard (Zigbee® and Z-Wave®), the IEEE 802.15.1 standard (Bluetooth®), a cellular network, a wireless local area network, near-field communication protocol, Ultra WideBand (UWB) wireless communication protocol, and/or other networking and/or communication protocols. In some examples, the electronic lock 100 can wirelessly communicate with networked and/or distributed computing systems, such as may be present in a cloud-computing environment.

In a particular embodiment, the processor 136 will receive a signal at the Bluetooth interface 140 via a wireless communication protocol (e.g., BLE) from a mobile device 200 for communication of an intent to actuate the electronic lock 100. As illustrated in further detail below, the processor 136 can also initiate communication with the server 250 via Wi-Fi interface 139 (or another wireless interface) for purposes of validating an attempted actuation of the electronic lock 100, or receiving an actuation command to actuate the electronic lock 100. Additionally, various other settings can be viewed and/or modified via the Wi-Fi interface 139 from the server 250; as such, a user 12 of a mobile device 200 may access an account associated with the electronic lock 100 to view and modify settings of that lock, which are then propagated from the server 250 to the electronic lock 100. In alternative embodiments, other types of wireless interfaces can be used; generally, the wireless interface used for communication with a mobile device can operate using a different wireless protocol than a wireless interface used for communication with the server 250.

In a particular example, the Bluetooth interface 140 comprises a Bluetooth Low Energy (BLE) interface. Additionally, in some embodiments, the Bluetooth interface 140 is associated with a security chip 141, for example, a cryptographic circuit capable of storing cryptographic information and generating encryption keys usable to generate certificates for communication with other systems, e.g., mobile device 200.

The interior assembly 108 also includes the battery 142 to power the electronic lock 100. In one example, the battery 142 may be a standard single-use (disposable) battery. Alternatively, the battery 142 may be rechargeable. In still further embodiments, the battery 142 is optional altogether, replaced by an alternative power source (e.g., an AC power connection).

The interior assembly 108 also includes the motor 132 that is capable of actuating the bolt 114. In use, the motor 132 receives an actuation command from the processing unit 116, which causes the motor 132 to actuate the bolt 114 from the locked position to the unlocked position or from the unlocked position to the locked position. In some examples, the motor 132 actuates the bolt 114 to an opposing state. In some examples, the motor 132 receives a specified lock or unlock command, where the motor 132 only actuates the bolt 114 if the bolt 114 is in the correct position. For example, if the door 14 is locked and the motor 132 receives a lock command, then no action is taken. If the door 14 is locked and the motor 132 receives an unlock command, then the motor 132 actuates the bolt 114 to unlock the door 14.

As noted above, the optional interior antenna 134 may also be located in the interior assembly 108. In some examples, the interior antenna 134 is capable of operating together with the exterior antenna 130 to determine the location of the mobile device 200. In some examples, only a mobile device determined to be located on the exterior side 106 of the door 14 is able to unlock (or lock) the door 14. This prevents unauthorized users from being located near the electronic lock 100 and taking advantage of an authorized mobile device that may be located on the interior side 104 of the door 14, even though the authorized mobile device is not being used to unlock the door 14. In alternative embodiments, the interior antenna 134 can be excluded entirely, since the electronic lock 100 is actuated only by an authorized mobile device.

In alternative embodiments, one of the exterior antenna 130 and optional interior antenna 134 may be excluded, and an antenna array may be provided exclusively within the interior or exterior assembly. In such arrangements, wireless positioning technologies, such as Ultra-wideband wireless communication, may be used to detect a position of a device in communication with the electronic lock 100, e.g., by using an antenna array within one or the other of the interior or exterior assembly.

Referring to FIGS. 1-4 generally, in example embodiments, the electronic lock 100 may be used on both interior and exterior doors. Described herein are non-limiting examples of a wireless electronic lockset. It should be noted that the electronic lock 100 may be used on other types of doors, such as a garage door or a doggie door, or other types of doors that require an authentication process to unlock (or lock) the door.

In some embodiments, the electronic lock 100 is made of mixed metals and plastic, with engineered cavities to contain electronics and antennas. For example, in some embodiments, the lock utilizes an antenna near the exterior face of the lockset, designed inside the metal body of the lockset itself. The metal body can be engineered to meet strict physical security requirements and also allow an embedded front-facing antenna to propagate RF energy efficiently.

In still further example embodiments, the electronic lock 100 can include an integrated motion sensor 135. Using such a motion sensor (e.g., an accelerometer, gyroscope, or other position or motion sensor) and wireless capabilities of a mobile device or an electronic device (i.e., fob) with these capabilities embedded inside can assist in determining additional types of events (e.g., a door opening or door closing event, a lock actuation or lock position event, or a knock event based on vibration of the door). In some cases, motion events can cause the electronic lock 100 to perform certain processing, e.g., to communicatively connect to or transmit data to a mobile device 200 in proximity to the electronic lock 100.

Of course, in alternative embodiments, other lock actuation sequences may not require use of a motion sensor 135. For example, if the mobile device 200 is in valid range of the electronic lock 100 when using a particular wireless protocol (e.g., Bluetooth Low Energy), then a connection will be established with the electronic lock 100. Other arrangements are possible as well, using other connection sequences and/or communication protocols.

FIG. 5 illustrates an environment 10 in which a user 12 may control the electronic lock 100 or may customize settings for the electronic lock 100 through a mobile device or other computing device 200 with wireless communication capabilities. The mobile device 200 is capable of communicating 22 with a server 250 and communicating 20 with the electronic lock 100. The server 250 may be, for example, a physical server or a virtual server hosted in a cloud storage environment 16. In some embodiments, the electronic lock 100 is also capable of communicating 24 with the server 250. Such communication can optionally occur via one or more wireless communication protocols, e.g., Wi-Fi® (IEEE 802.11), short-range wireless communication to a Wi-Fi® bridge, or other connection mechanism. The server 250 may authenticate the electronic lock 100 before establishing a secure connection. Alternatively, the electronic lock 100 can authenticate the server 250 to establish a secure connection. In some instances, the server 250 and the electronic lock 100 operate to mutually authenticate each other in order to provide a higher level of security when establishing a connection. In still further embodiments, the server 250 may be excluded entirely, and configuration of the electronic lock 100 may be performed via direct communication connection between the mobile device 200 and the electronic lock 100.

The server 250 can be, for example, a physical server or a virtual server hosted in a cloud storage environment 16. In some embodiments, the electronic lock 100 is also capable of communicating 24 with the server 250. Such communication can optionally occur via one or more wireless communication protocols, e.g., Wi-Fi (IEEE 802.11), short-range wireless communication to a Wi-Fi bridge, or other connection mechanism. According to an embodiment, the server 250 generally creates and stores a user account associated with the electronic lock 100, stores a pairing passcode for the electronic lock 100, and stores settings for the electronic lock 100.

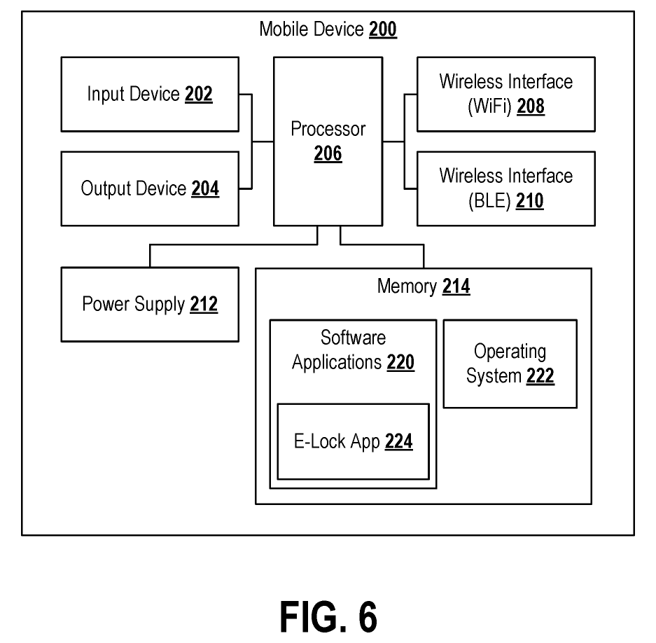

FIG. 6 illustrates a schematic diagram of a mobile device, such as mobile device 200, usable in embodiments of the disclosure to control the electronic lock 100 or customize settings for the electronic lock 100. In some embodiments, the mobile device 200 operates to form a Bluetooth or BLE connection with a network enabled security device such as the electronic lock 100. The mobile device 200 shown in FIG. 6 includes an input device 202, an output device 204, a processor 206, a wireless Wi-Fi interface 208, a wireless BLE interface 210, a power supply 212, and a memory 214.

The input device 202 operates to receive input from external sources. Such sources can include inputs received from a user (e.g., the user 12). The inputs can be received through a touchscreen, a stylus, a keyboard, etc.

The output device 204 operates to provide output of information from the mobile device 200. For example, a display can output visual information while a speaker can output audio information.

The processor 206 reads data and instructions. The data and instructions can be stored locally, received from an external source, or accessed from removable media.

The wireless Wi-Fi interface 208 is similar to the Wi-Fi interface 139. A Wi-Fi connection 22 can be established with the server 250.

The wireless BLE interface 210 is similar to the Bluetooth interface 140. A BLE connection 20 can be established with the electronic lock 100.

The power supply 212 provides power to the processor 206.

The memory 214 includes software applications 220 and an operating system 222. The memory 214 contains data and instructions that are usable by the processor to implement various functions of the mobile device 200.

The software applications 220 can include applications usable to perform various functions on the mobile device 200. One such application is an electronic lock application 224. In a particular embodiment, when the electronic lock application 224 is operating on the mobile device 200, the electronic lock application 224 can be configured to provide a user interface, setup/activate the electronic lock 100, generate a user account that is associated with the electronic lock 100, actuate the electronic lock 100, and customize settings of the electronic lock 100.

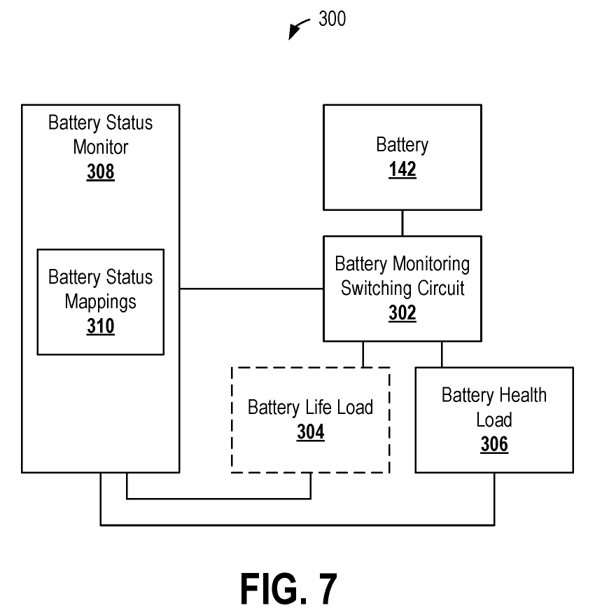

Referring now to FIGS. 7-15, details regarding battery monitoring and protection in an electronic lock is described. Examples described herein relate to three battery monitoring and protection circuits. Some embodiments of an electronic lock may include each of the battery monitoring and protection circuits described here. In other embodiments of an electronic lock, a subset of the battery monitoring and protection circuits are included. In further embodiments of an electronic lock, the electronic lock may include additional or alternative battery monitoring and protection circuits.

FIGS. 7-9 describe a battery status monitoring circuit. In embodiments, the battery monitoring circuit may monitor battery life. In an example, the battery life of the battery measures the remaining charge on the battery. Battery life may be determined, for example, by a current output voltage, or voltage response, obtained from a battery; a lower output voltage may indicate a relatively lower battery life remaining; additionally, a voltage under load that results in a voltage drop may indicate that a battery is unable to supply adequate power for a predetermined purpose. By monitoring the battery life of the battery in the electronic lock, a user can determine when to replace or recharge the battery. Similarly, the electronic lock may provide notifications to a user to replace or recharge the battery when the electronic lock determines the battery life is below a threshold value (e.g., 20%).

In embodiments, a battery status monitoring circuit may additionally or alternatively monitor a battery health of the battery in the electronic lock. In an example, the battery health measures a condition of the battery compared to an ideal condition (e.g., when the battery was new). For example, the battery health may compare the voltage of the battery at different loads (e.g., a strong load and a weak/no load). As a battery is used, its capacity may deteriorate, and the battery health may be lower. By monitoring the battery health of the battery in the electronic lock, a user can determine when to replace the battery. Similarly, the electronic lock may provide notifications to a user to replace the battery when the electronic lock determines the battery health is below a threshold value (e.g., 70%).

FIG. 7 illustrates a schematic diagram of an example battery status monitoring circuit 300. As shown in FIG. 7, the battery status monitoring circuit 300 includes a battery 142, a battery monitoring switching circuit 302, a battery life load 304, a battery health load 306, and a battery status monitor 308. As described further herein, the battery life load 304 and the battery health load 306 may be electrical loads. In an embodiment, the battery status monitor 308 is part of a processer of the electronic lock (e.g., the processor 136 described above in connection with FIG. 4).

In an embodiment, by default, the battery monitoring switching circuit 302 may connect the battery 142 with the battery life load 304. Accordingly, in this electrical configuration, the battery status monitor 308 can estimate a battery life of the battery 142. In an example, as described further herein, the battery life load 304 may have a high resistance (and thus draw a small current), and by monitoring a voltage supplied by the battery 142 across the battery life load 304, the battery status monitor 308 may estimate the battery life of the battery 142. For example, the battery status monitor 308 may use a predefined equation to correlate the measured voltage at the battery life load 304 to a battery life. In another example, the battery status monitor 308 may use a look-up table or other data structure to map the measured voltage to a battery life. In embodiments, the battery status monitor 308 may include battery status mappings 310 that map the measured voltage to the battery life. In an example, the battery status mappings 310 are determined based on tests in which voltages are measured at a plurality of times as a battery is drained (e.g., the battery reaches a brownout).

To measure a battery health of the battery 142, the battery monitoring switching circuit 302 may be activated to selectively connect the battery 142 to the battery health load 306. In examples, the battery health load 306 simulates an average maximum load on the battery 142, such as a load experienced when operating a motor to extend a bolt or a load experienced when operating one or more wireless interfaces, or a combination of various loads that may occur concurrently. In some embodiments, the battery monitoring switching circuit 302 may be activated by a battery status monitor 308, which may be included in a processor of an electronic lock. The battery monitoring switching circuit 302 may, in some embodiments, disconnect the battery 142 from the battery life load 304 when connecting the battery 142 to the battery health load 306. In other embodiments, the battery 142 may be concurrently connected to both the battery life load 304 and the battery health load 306 when measuring the battery health. In such embodiments, because the battery health load 306 may have a lower resistance than the battery life load 304 (which may be configured to have a high resistance to reduce the current draw from the battery 142 when the battery life load 304 is connected to the battery 142), substantially none of the current supplied by the battery 142 is supplied to the battery life load 304 when measuring the battery health of the battery 142.

Like when monitoring the battery life, the battery status monitor 308 may determine the battery health of the battery 142 by measuring a voltage at the battery health load 306. In examples, the battery status monitor 308 may use a predefined equation to correlate the measured voltage at the battery health load 306 to a battery health. In another example, the battery status monitor 308 may use a look-up table or other data structure to map the measured voltage to a battery health. In embodiments, the battery status mappings 310 may include mappings between the measured voltage and a battery health. In some embodiments, the battery status monitor 308 may compare the measured voltage at the battery health load 306 to measured voltage at the battery life load 304, and a difference in the measured voltages or a ratio of the measured voltages may be used to determine the battery health of the battery 142.

In some embodiments, the battery status monitoring circuit 300 may include both the battery life load 304 and the battery health load 306. In alternative embodiments, the battery status monitoring circuit may include one of the battery life load 304 or the battery health load 306. For example, in an embodiment, the battery status monitoring circuit 300 may include the battery health load 306, but not the battery life load 304.

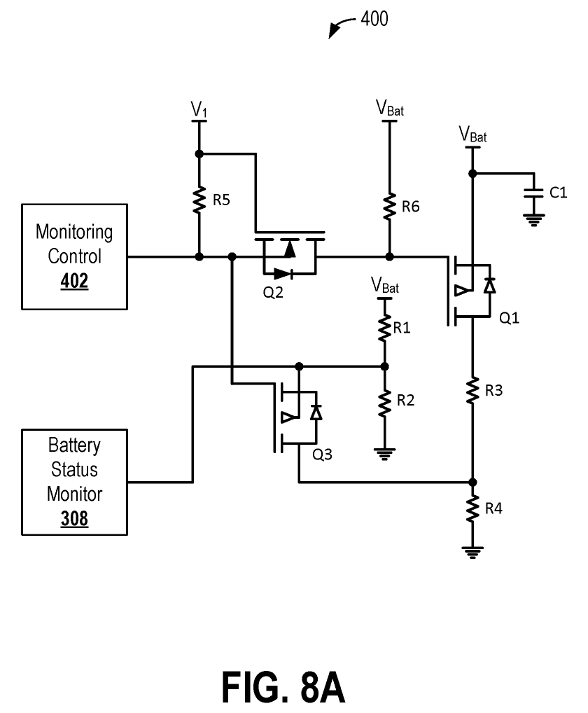

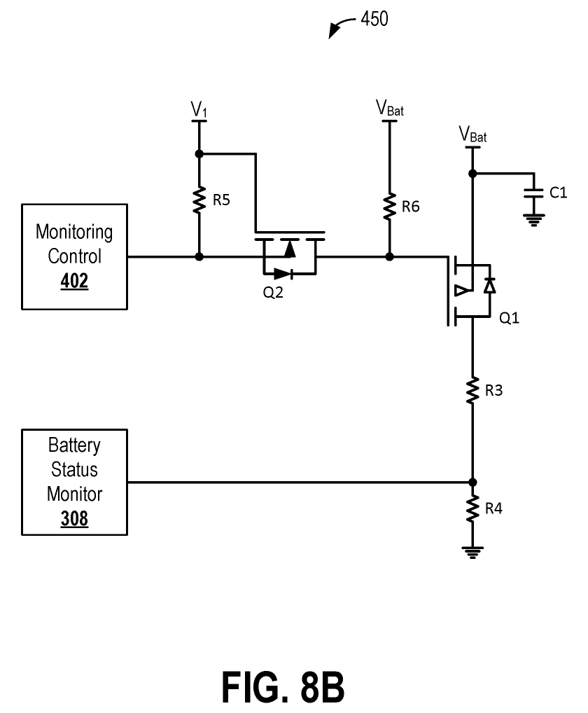

FIG. 8A illustrates a first example circuit diagram 400 of the battery status monitoring circuit 300 described above. In the illustrated example, the circuit diagram 400 includes a plurality of resistors R1-6, electrical switches (shown as MOSFET transistors Q1-3) and a capacitor Q1. A monitoring control 402 control whether battery life or battery health is monitored. A battery status monitor 308, as described above, may monitor the battery life and/or battery health of a battery (e.g., the battery 142 described above). In embodiments, the monitoring control 402 and the battery status monitor 308 are components of a processor of the electronic lock (e.g., the processor 136 described above in connection with FIG. 4). For example, the battery status monitor 308 may be a battery monitoring pin of the processor.

Voltage may be supplied to the circuit 400 at one or more voltages, shown as V₁ and V_{Bat} in FIG. 8A. In embodiments, V₁ is a predefined constant voltage, such as 3.3V, and V_{Bat} is the voltage of the battery. In an example, V₁ and V_{Bat} are supplied by the battery, but a buck converter or other voltage regulator is used to regulate V₁ to be the predefined voltage.

In the illustrated embodiment, the electrical switches (e.g., transistors Q1-3) act as the battery monitoring switching circuit 302 described above. A first voltage divider including resistors R1 and R2 may act as the battery life load 304 described above, and a second voltage divider including resistors R3 and R4 may act as the battery health load 306 described above.

By default, none of the electrical switches are closed. That is, when implemented as transistors Q1-Q3, none of the transistors are active, and voltage from the battery is supplied to the first voltage divider (R1 and R2). Accordingly, the battery status monitor 308 can determine the voltage of the battery (V_{Bat}) when little current is drawn from the battery. For example, because resistance values of the resistors R1 and R2 are known, the battery status monitor 308 can use the voltage measured across the resistor R2 to determine the voltage of the battery (V_{Bat}) using Ohm’s Law. As described above, the battery status monitor 308 may then convert the determined voltage of the battery to a battery life of the battery, such as by using a predefined equation or predefined mappings between voltage and battery life values. In an embodiment, the resistor R1 has a resistance of 698 kilohms, and the resistor R2 has a resistance of 330 kilohms. In alternative embodiments, different resistance values may be used for the resistors R1 and R2. In embodiments, the resistors R1 and R2 have a high resistance value such that a comparatively lower current (e.g., as compared to the current drawn through the resistors R3, R4 discussed below) is drawn from the battery through the resistors R1 and R2.

To determine the battery health of the battery, the monitoring control 402 may send an electrical signal to the circuit 400 that causes the transistors Q1-3 to activate. When the transistors Q1-3 activate, the battery status monitor 308 may be connected to both the first voltage divider (R1 and R2) and the second voltage divider (R3 and R4). In an embodiment, the resistors R3 and R4 have a lower resistance than the resistors R1 and R2 such that a comparatively higher current will flow through the resistors R3 and R4 when measuring battery health. Accordingly, the battery status monitor 308 can determine the battery voltage (V_{Bat}) under the load of the second voltage divider (R3 and R4) by measuring the voltage across the resistor R4 and calculating the battery voltage using Ohm’s Law (since the effect of the R1-R2 voltage divider is negligible on that voltage).

In an embodiment, the battery status monitor 308 compares the voltage of the battery when under the load of the second voltage divider (R3 and R4) to the voltage of the battery when under the load of the first voltage divider (R1 and R2) to determine the battery health of the battery. For example, the battery health of the battery may be calculated as a ratio of the battery voltages under the different loads of the first and second voltage dividers. In other examples, a voltage response may be monitored in various configurations of the battery monitor to determine battery response to changes in load.

In an embodiment, the resistor R3 has a resistance of 22 ohms, and the resistor R4 has a resistance of 10 ohms. In example embodiments, the resistances of the resistors R3 and R4 are selected such that the load experienced by the battery when connected to the resistors R3 and R4 matches an average maximum load on the battery during operation of the electronic lock. In an example, the resistances of the resistors R3 and R4 may be selected to simulate the load experienced by the battery when operating a motor to extend or retract a bolt. For example, the resistances of the resistors R3 and R4 are selected such that the current draw from the battery when connected to the resistors R3 and R4 is 200 milliamps. In other examples, the maximum load on the battery may occur at different times during operation of the electronic lock, such as during operation of wireless interfaces (e.g., the wireless interfaces 139, 140 described above in connection with FIG. 4). In such examples, the resistances of the resistors R3 and R4 may be selected to simulate the load on the battery during these operations. In alternative embodiments, the resistances of the resistors R3 and R4 may be different values, such as to simulate different load conditions on the battery.

In an embodiment, the resistors R5 and R6 have resistances of 10 kilohms, and the capacitor C1 has a capacitance of 10 microfarads. In alternative embodiments, the resistors R5 and R6 may have different resistances, and the capacitor C1 may have a different capacitance. In examples, resistances of the resistors R5 and R6 and a capacitance of the capacitor C1 may be based on gate thresholds of one or more of the transistors Q1-3.

While FIG. 8A illustrates an example circuit diagram 400 for monitoring the battery life and battery health of the battery of the electronic lock, in alternative embodiments, different circuit configurations may be used and/or different electrical components may be included in the circuit. For example, while the circuit diagram 400 includes MOSFET transistors Q1-3, in alternative embodiments, other types of transistors or electrical/electronic switches may be used to control the connection of the battery to loads with which the battery life and the battery health are measured.

Additionally, while the embodiment described above describes measuring the voltage of the battery a single time to determine battery life and battery health, in alternative embodiments, the battery may be connected to the resistor dividers (R1 and R2, or R3 and R4) multiple times, and multiple readings of the battery voltage may be used to calculate battery life and battery health.

FIG. 8B illustrates a second example circuit diagram 450 status monitoring circuit 300 described above in connection with FIG. 7. In contrast to the embodiment shown in FIG. 8A, the circuit 450 illustrated in FIG. 8B includes a battery health load (shown as the voltage divider including resistors R3 and R4) but does not include a battery life load. In operation, like with the circuit 400 shown in FIG. 8A, a signal from a monitoring control 402 may cause resistors Q1 and Q2 to activate, allowing a battery status monitor 308 to determine a battery voltage when the battery is connected to the battery health load (resistors R3 and R4). As described above, the battery voltage may be determined by measuring the voltage across the resistor R4 and using Ohm’s Law to calculate the battery voltage. The battery health may then be determined based on the measured battery voltage, such as by using predefined mappings between voltages and battery health values.

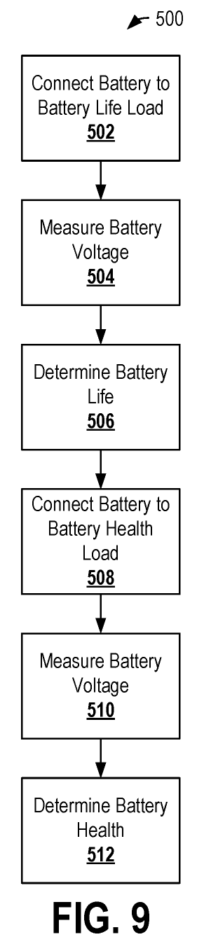

FIG. 9 illustrates a flowchart of an example method 500 for monitoring a battery life and a battery health of a battery in an electronic lock. In the illustrated example, the method 500 includes operations 502, 504, 506, 508, 510, 512. In an embodiment, the method 500 is performed by a battery monitoring circuit.

The operation 502 includes connecting the battery to a battery life load. In an example, a battery monitoring switch controls the connection of the battery to the battery life load. In embodiments, the battery life load includes a voltage divider comprising two or more resistors, and a resistance of the resistors in the voltage divider is high such that a current draw from the battery when connected to the battery life load is low.

The operation 504 includes measuring a battery voltage when the battery is connected to the battery life load. In an example, the battery voltage is determined by measuring an output voltage at a voltage divider and using Ohm’s Law to determine the voltage of the battery.

The operation 506 includes determining a battery life of the battery. In an example, the battery voltage measured during the operation 504 may be determine the battery life. For example, a predefined equation may be used to calculate the battery life based on the measured voltage. In another example, a look-up table or other data structure may be referenced to map the measured voltage to a battery life.

The operation 508 includes connecting the battery to a battery health load. In an embodiment, like the battery life load, the battery health load may include a voltage divider. In an example, a resistance of the battery health load may be lower than the resistance of the battery life load. In embodiments, the resistance of the battery health load may be set to simulate a load placed on the battery during operation of a motor to extend or retract a bolt of the electronic lock.

The operation 510 includes measuring a battery voltage when the battery is connected to the battery health load. Like the operation 504, in an example, the voltage is determined by measuring an output voltage at a voltage divider and using Ohm’s Law to determine the voltage of the battery.

The operation 512 includes determining a battery health of the battery. In an example, the battery voltage measured during the operation 510 may be determine the battery life. For example, a predefined equation may be used to calculate the battery health based on the measured voltage. In another example, a look-up table or other data structure may be referenced to map the measured voltage to a battery health. In some embodiments, the battery health may be determined based on a difference between the voltage measured during the operation 504 when and the voltage measured during the operation 510—i.e., the battery voltages when connected to the battery life load and the battery health load.

In alternative embodiments, the method 500 may include additional or alternative operations. Additionally, in some embodiments, the method 500 may include fewer operations. For example, in an embodiment, an electronic lock may include a battery health load but not a battery life load. Accordingly, in such embodiments, the method 500 may include the operations 508, 510, 512 to determine the battery health of the battery, but not the operations 502, 504, 506 to determine the battery life of the battery.

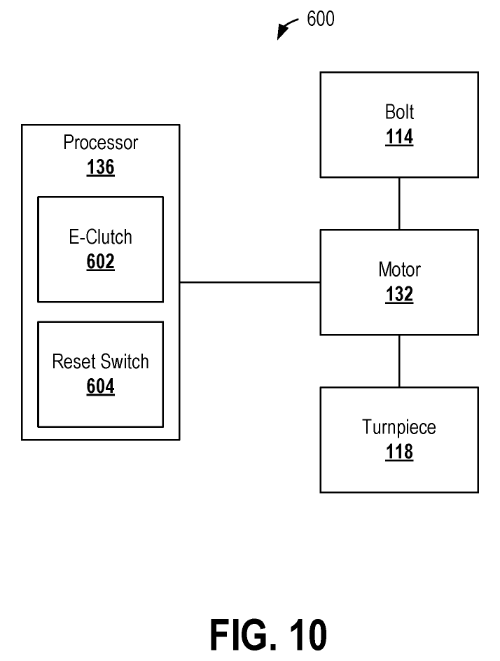

FIGS. 10-12 describe a motor runaway protection circuit. As described above, in embodiments, an electronic lock includes a motor configured to move a bolt between extended and retracted positions. In an example, a clutch or other similar mechanism may be used to control the motor when driving the bolt; when the bolt is fully extended/retracted, the clutch may engage to stop the motor from continuing to drive the bolt. In some embodiments, the clutch may be an electronic clutch controlled by a processor of the electronic lock. For example, the electronic clutch may engage when the processor detects a voltage representative of a current draw of the motor exceeds a threshold. The voltage representative of the current draw of the motor may be measured by measuring a voltage across a shunt resistor (e.g., a resistor with a low resistance, such as 1 deciohm) at an input of the motor. Because the current draw of the motor may increase when the bolt is fully extended/retracted and the motor attempts to push/pull the bolt further, the monitored voltage may increase as well. Accordingly, monitoring the voltage representative of the current draw of the motor allows the electronic clutch to determine when the bolt is fully extended/retracted.

However, in some cases, an error may cause the electronic clutch to not engage. In these cases, the motor may continue to draw power from the battery in an attempt to extend/retract the bolt further, and the current drawn by the motor may continue to increase. This may cause the battery to drain quickly and may damage the battery if too much power is drawn by the motor. Additionally, mechanical components of the electronic lock, such as gears in the motor, may break as the motor outputs increasing force.

To protect the battery against these errors, the electronic lock may include a motor runaway protection circuit. In embodiments, as described herein, the motor runaway protection circuit may also monitor the voltage representative of the current drawn by the motor, and if the voltage exceeds a threshold—which is above the threshold at which the electronic clutch should engage—the motor runaway protection circuit deactivates the motor.

FIG. 10 illustrates a schematic diagram of an example motor runaway protection circuit 600. In the illustrated embodiment, the motor runaway protection circuit 600 includes a processor 136 that includes an electronic clutch 602 (shown as “E-Clutch”), and a reset switch 604. The motor runaway protection circuit 600 is electrically connected to a motor 132, which is physically coupled to a bolt 114 and a manual turn piece 118, as described above.

As described above, in normal operation, the motor 132 may drive the bolt 114 to move the bolt 114 between extended and retracted positions to lock/unlock a door. During normal operation of the motor 132, the processor 136 implements an electronic clutch 602, which causes engagement with the motor 132 to cause extension/retraction of the bolt 114. For example, the clutch 602 may monitor a voltage representative of a current draw of the motor 132, and when the voltage exceeds a predetermined threshold, the clutch 602 may programmatically determine that the bolt 114 has reached an end state or is otherwise blocked, and subsequently engages to deactivates the motor 132. In examples, the threshold voltage is determined based on a current draw of the motor 132 when the bolt 114 is fully extended/retracted, or observed states where the bolt 114 may be blocked. In an embodiment, the threshold is 1.5 volts. The voltage representative of the current draw of the motor 132 may be determined by using a shunt resistor with a low resistance (e.g., 1 deciohms) to convert the current draw of the motor 132 into a voltage value.

In some cases, as explained above, the motor may be engaged using a gradually increasing current draw to increase torque applied by the motor 132 to the bolt 114, for example to ensure proper bolt extension/retraction. However, in some cases, errors may prevent the clutch 602 from engaging. For example, a particular clutch end state may not be caught by the electronic clutch 602. This will allow the motor 132 to run after the bolt 114 is fully extended/retracted. In these cases, the motor 132 will continue to draw increasing power from the battery (i.e., the motor is in a runaway state), which may result in unnecessary battery draw, as well as damage the battery and mechanical components of the electronic lock. The reset switch 604 protects the electronic lock by preventing the motor 132 from operating in the runaway state for extended periods of time.

In an embodiment, like the clutch 602, the reset switch 604 monitors the voltage representative of the current draw of the motor 132. When the voltage exceeds a threshold defined by circuit in the reset switch 604, the reset switch 604 deactivates the motor 132. The threshold voltage at the which the reset switch 604 activates may be a higher threshold than the threshold at which the clutch 602 causes engagement or disengagement of the motor 132.

In an embodiment, to deactivate the motor 132, the reset switch 604 resets the processor 136, which in turn deactivates the motor 132. In some examples, the reset switch 604 causes a full reset of the processor 136. In alternative examples, the reset switch 604 causes a partial reset of the processor 136. In further examples, the reset switch 604 may reset other components of the electronic lock. For example, the reset switch 604 may reset the motor 132, thereby interrupting its continued operation. In an embodiment in which the reset switch 604 reset the motor 132, the reset switch 132 may cause the motor 132 to toggle the motor 132 on and off, limiting the motor 132 to the threshold voltage. In such an embodiment, a timer may be used to determine how long the motor has run, and if the motor has run for a predetermined amount of time, the motor is deactivated.

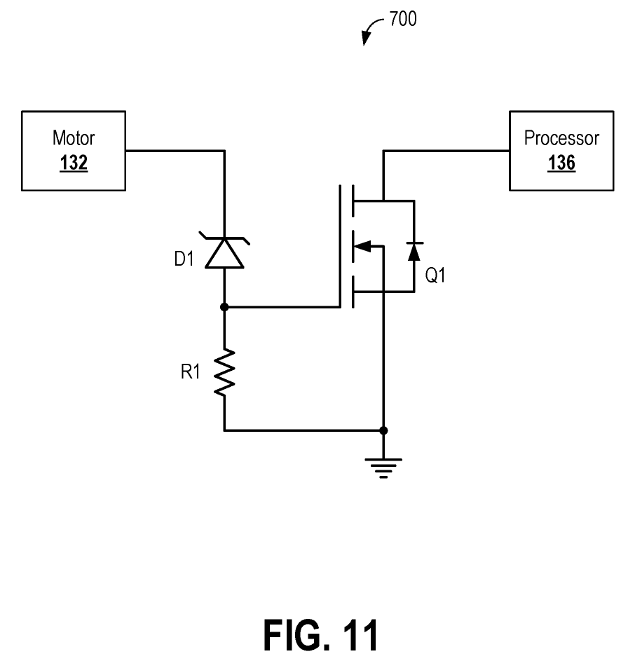

FIG. 11 illustrates an example circuit diagram 700 of a motor runaway protection circuit. In the illustrated embodiment, the circuit 700 includes a diode D1, an electrical switch (in this case, implemented using a transistor Q1), and a resistor R1. In an embodiment, the diode D1 is a Zener diode, and the transistor Q1 is an N-channel MOSFET. In the illustrated example, a motor 132 is connected to the circuit 700 at a cathode of the diode D1, and a processor 136 is connected to a drain of the transistor.

During operation of the motor 132, a voltage at the motor 132 that is indicative of current draw of the motor 132 is input to the cathode of the diode D1. In an example, the voltage representative of the current draw of the motor 132 is a voltage across a shunt resistor. In some embodiments, the voltage across the shunt resistor may be amplified to make the voltage easier to monitor. If the motor 132 enters a runaway state (e.g., a clutch does not disengage the motor, causing the motor 132 to continue to operate when a bolt is fully extended/retracted or otherwise blocked), the voltage may progressively increase as the motor 132 draws more power from a battery (i.e., the current draw of the motor 132 increases). Initially, the diode D1 may prevent current drawn by the motor 132 from entering the rest of the circuit 700; however, when the voltage representative of the current draw of the motor 132 exceeds a breakdown voltage of the diode D1, a voltage at the anode of the diode D1 will begin to increase. When the voltage at the anode of the diode D1 increases, the transistor Q1 may activate initiating a reset operation of at least some component of the electronic lock. In examples, when the voltage at the anode of diode D1 reaches a gate activation voltage, the transistor Q1 connects the processor 136 to a reset signal (e.g., ground).

In an embodiment, a reset pin of the processor 136 is connected to ground when the transistor Q1 activates, causing the processor 136 to reset and stopping operation of the motor 132. In some embodiments, the processor 136 undergoes a full reset. In alternative embodiments, the processor 136 undergoes a partial reset. Additionally, in alternative embodiments, the reset pin of the processor 136 may be connected to other reset values (e.g., other voltages) to initiate a reset operation; the specific value selected may be based on an implementation of the processor 136.

In examples, the diode D1 is selected based on the breakdown voltage of the diode D1; the breakdown voltage of the diode D1 sets a voltage threshold at which the processor 136 resets. In an embodiment, the diode D1 has a breakdown voltage of 2.4 volts. In this embodiment, a clutch may be configured to engage when the voltage representative of the current draw of the motor 132 is 1.5 volts. Accordingly, the motor runaway protection circuit 700 acts as a backup should the clutch fail to properly engage. In other embodiments, diodes with different breakdown voltages may be used based on the desired voltage at which the processor 136 resets, which may be based on the threshold voltage at which a clutch is intended to engage.

While the example embodiment includes a diode D1 and a transistor Q1, in alternative embodiments, different electrical components, such as different switches, may be used to selectively reset the processor 136 based on a voltage of the motor 132. Additionally, in embodiments, the resistor R1 has a resistance of 470 kilohms. In an example, the resistance of the resistor R1 may be based on a gate threshold of the transistor Q1 or a breakdown voltage of the diode D1, or both. In alternative embodiments, different resistance values may be used for the resistor R1.

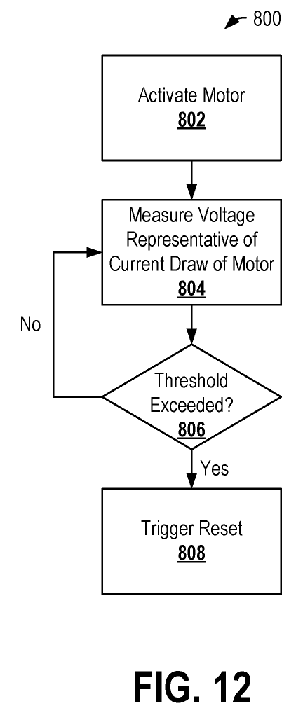

FIG. 12 illustrates a flowchart of an example method 800 for protecting against a runaway motor in an electronic lock. In the illustrated example, the method 800 includes operations 802, 804, 806, and 808. In an embodiment, the method 800 is performed by a runaway motor protection circuit.

The operation 802 includes activating a motor. In an example, the motor may be activated to extend or retract a bolt, such as to lock or unlock a door. In an example a processor of the electronic lock sends a signal to the motor to activate the motor.

The operation 804 includes measuring a voltage representative of a current draw of the motor. In an example the voltage may be measured by converting a current draw of the motor using a shunt resistor (e.g., a resistor with a resistance of one deciohm). During normal operation of the motor, the voltage representative of the current draw may be used to trigger a clutch when the bolt is fully extended or retracted. However, errors may prevent the clutch from engaging (e.g., missing when an increasing voltage/current provided to the motor exceeds a threshold), causing the motor to enter a runaway state.

The operation 806 includes determining if the measured voltage representative of the current draw of the motor exceeds a predetermined threshold. In an example, the threshold is set based on a voltage at which the clutch is intended to engage to deactivate the motor. In an example, the clutch is configured to engage when the voltage representative of the current draw of the motor is 1.5 volts, and the threshold is set at 2.5 volts. If the measured voltage does not exceed the threshold, the method 800 returns to the operation 804, and the voltage is measured again. The operations 804 and 806 may loop until the measured voltage exceeds the threshold or the motor deactivates.

If the voltage representative of the current draw of the motor exceeds the threshold, the method 800 proceeds to the operation 808. In an example, the operation 808 includes triggering a reset. In an embodiment, when the voltage representative of the current draw of the motor exceeds the threshold, a reset of a processor of the electronic lock is triggered—either as a full reset or a partial reset. In examples, resetting the processor causes the motor to deactivate. In alternative embodiments, other components of the electronic lock may additionally or alternatively be reset. For example, the motor may be reset. In an embodiment, motor is repeatedly turned on and off, causing the current draw of the motor to plateau and the measured voltage to stay at the threshold voltage. A timer may then be used to determine a timeout at which the motor is deactivated.

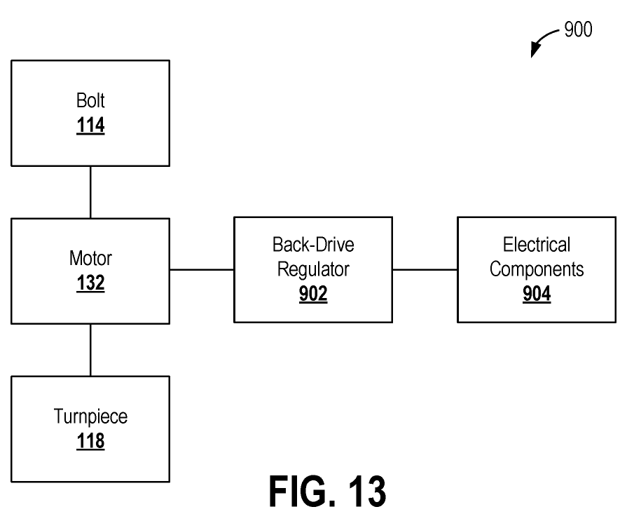

FIG. 13-15 describe a motor back-drive protection circuit. In an example, when a manual turn piece (e.g., turn piece 118) of an electronic lock is rotated to extend or retract a bolt, a motor in the electronic lock may enter a back-drive state in which a voltage is generated by the motor, which may be harmful to electrical components of the electronic lock. This is because, in some electronic locks, the turn piece 118 is directly coupled to the motor 132, which is in turn directly coupled to electronics of the lock, such as processor 136. In some cases, the speed at which the turn piece is rotated may affect the voltage generated by the motor in the back-drive state: the faster the turn of the turn piece, the higher the voltage generated by the motor. To protect the electronics of the lock against the back-drive voltage, a motor back-drive protection circuit may prevent the back-drive voltage generated by the motor from exceeding a predetermined threshold.

FIG. 13 illustrates a schematic diagram of an example motor back-drive protection circuit 900. In the illustrated embodiment, the motor back-drive protection circuit includes a back-drive regulator 902 that is electrically connected between a motor 132 and electrical components 904 of the electronic lock, such as the processor 136 described above. The motor 132 is directly coupled, in the example shown, to bolt 114 and manual turn piece 118.

In example embodiments, the turn piece 118 and the motor 132 may be connected to a bolt 114 such that the turn piece 118 and the motor 132 can both extend and retract the bolt 114. In some cases, however, when the turn piece 118 is rotated to extend/retract the bolt 114, the motor 132 may enter a back-drive state in which the motor 132 generates a voltage due to the rotation of the turn piece 118. This back-drive voltage may harm the electrical components 904.

To protect system electronics against the back-drive voltage, the back-drive regulator 902 may monitor the voltage generated by the motor 132. If the voltage generated by the motor 132 exceeds a predetermined threshold, the back-drive regulator 902 may clamp the voltage, preventing the back-drive voltage generated by the motor 132 during rotation of the turn-piece from reaching a level that would damage the electrical components 904. In an example, the threshold at which the back-drive regulator clamps the back-drive voltage is 5 volts.

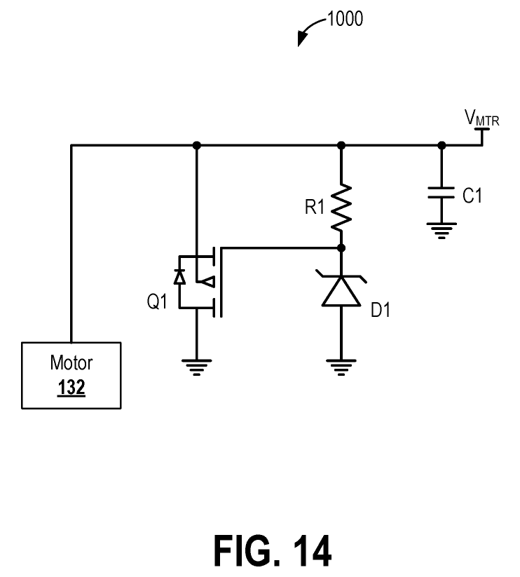

FIG. 14 illustrates an example circuit diagram 1000 of a motor back-drive protection circuit. In the illustrated example, the circuit 1000 includes an electronic switch, such as transistor Q1, as well as a diode D1, a resistor R1, a capacitor R1, and a motor 132. In an example, the circuit 1000 is connected to the motor 132, such as at an input pin of motor drive circuitry of the motor 132. In this embodiment, the transistor Q1 and the diode D1 may act as a back-drive regulator to clamp a back-drive voltage generated by the motor 132 during rotation of a turn piece.

As described above, when a turn piece is rotated, the motor 132 may generate a back-drive voltage (illustrated as V_{MTR} in FIG. 14). The diode D1 and the electronic switch (shown as transistor Q1) may work in combination to clamp the back-drive voltage, preventing the back-drive voltage from exceeding a threshold. For example, if the back-drive voltage exceeds the threshold, a voltage at a cathode side of the diode D1 may be below a voltage at a source of the transistor Q2. In this state, the transistor Q1 may sink current through the transistor Q1 until the back-drive voltage falls back below the threshold.

In an example, the threshold of the back-drive voltage is 5 volts. In embodiments, the threshold is set based on a normal operating voltage of a driver of the motor 132. For example, in an embodiment, the threshold of the back-drive voltage is set at 5 volts based on the normal operating voltage of the driver of the motor 132 being 4 volts. In embodiments, the threshold is controlled by a gate threshold of the transistor Q1 or a breakdown voltage of the diode D1, or both. Similarly, a resistance of the resistor R1 and a capacitance of the capacitor C1 may be based on the gate threshold of the transistor Q1 or a breakdown voltage of the diode D1, or both. In an embodiment, the resistor R1 has a resistance of 150 ohms, and the capacitor has a capacitance of 100 nanofarads.

While FIG. 14 illustrates an example circuit diagram 1000 for monitoring the electronics of the electronic lock, in alternative embodiments, different circuit configurations may be used and/or different electrical components may be included in the circuit. For example, while the circuit diagram 1000 includes a MOSFET transistor Q1 and a Zener diode D1, in alternative embodiments, other types of transistors, diodes, or switches may be used to clamp the back-drive voltage of the motor 132.

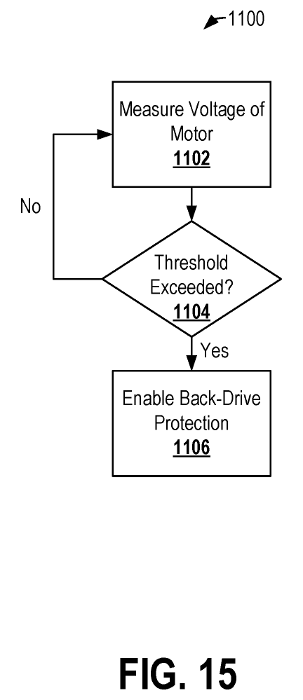

FIG. 15 illustrates a flowchart of an example method 1100 for protecting against motor back-drive. In the illustrated embodiment, the method 1100 includes operations 1102, 1104, 1106.

The operation 1102 includes measuring a voltage of a motor of the electronic lock. In examples, when a manual turn piece of the electronic lock is rotated to extend or retract a bolt, a voltage is generated by the motor. The voltage generated by the motor during rotation of the turn piece may be monitored during the operation 1102.

The operation 1104 includes determining whether the voltage generated by the motor during the operation 1102 exceeds a predetermined threshold. In an example, the threshold is set based on a normal operating voltage of a driver of the motor. For example, if the normal operating voltage of the driver of the motor is 4 volts, the threshold may be set at 5 volts. If the threshold is not exceeded, the method 1100 returns to the operation 1102, and the operations 1102 and 1104 may loop until the threshold is exceeded.

If the measured voltage exceeds the threshold, the method 1100 proceeds to the operation 1106. In an example, the operation 1106 includes enabling a back-drive protection. In an example, the back-drive protection clamps the voltage generated by the motor at the threshold. For example, as described above, a transistor my sink current through the transistor until the voltage generated by the motor falls below the threshold.

The various embodiments described above are provided by way of illustration only and should not be construed to limit the claims attached hereto. Those skilled in the art will readily recognize various modifications and changes that may be made without following the example embodiments and applications illustrated and described herein, and without departing from the full scope of the following claims.

1. An electronic lock, comprising:
a battery;
a battery status monitoring circuit including:
a battery health load, the battery health load simulating a load experienced by the battery during operation of the electronic lock;
a processing unit; and
a memory device storing instructions that, when executed by the processing unit, cause the electronic lock to:
selectively connect the battery to the battery health load;
determine a battery health voltage of the battery, the battery health voltage of the battery being a voltage supplied by the battery while the battery is connected to the battery health load; and
based on the battery health voltage, determine a battery health of the battery.

2. The electronic lock of claim 1, wherein the battery status monitoring circuit further includes a battery life load; and
wherein the instructions, when executed by the processing unit, further cause the electronic lock to:
connect the battery to the battery life load;
determine a battery life voltage of the battery, the battery life voltage of the battery being a voltage supplied by the battery while the battery is connected to the battery life load; and
based on the battery life voltage, determine a battery life of the battery.

3. The electronic lock of claim 2, wherein the battery life load includes a voltage divider comprising:
a first resistor having a first known resistance; and
a second resistor having a second known resistance.

4. The electronic lock of claim 3, wherein to determine the battery life voltage of the battery includes to:
determine a voltage across the second resistor; and
based on the voltage across the second resistor, determine the battery life voltage.

5. The electronic lock of claim 4, wherein to determine a battery life of the battery includes to:
map the battery life voltage of the battery to the battery life based on predefined mappings stored in the memory device.

6. The electronic lock of claim 3, wherein the battery health load includes a voltage divider comprising:
a third resistor having a third known resistance; and
a fourth resistor having a fourth known resistance.

7. The electronic lock of claim 6, wherein a cumulative resistance of the third resistor and the fourth resistor corresponds to an average maximum load on the battery during operation of a wireless interface.

8. The electronic lock of claim 6, wherein a cumulative resistance of the third resistor and the fourth resistor corresponds to an average maximum load on the battery when the motor operates to extend a bolt.

9. The electronic lock of claim 6, wherein to determine the battery health voltage of the battery includes to:
determine a voltage across the fourth resistor; and
based on the voltage across the fourth resistor, determine the battery health voltage.

10. The electronic lock of claim 2, wherein the battery health of the battery is determined based on a difference between the battery life voltage and the battery health voltage.

11. The electronic lock of claim 2, wherein the battery status monitoring circuit further comprises:
a battery monitoring switch configured to, in response to a signal from the processing unit, selectively connect the battery to at least one of the battery life load and the battery health load,
wherein the battery monitoring switch comprises one or more transistors.

12. An electronic lock, comprising:
a latch assembly including a bolt movable between a locked position and an unlocked position;
a motor configured to move the bolt from the locked position to the unlocked position or from the unlocked position to the locked position;
a processing unit; and
a motor runaway protection circuit, the motor runaway protection circuit configured to:
when the motor is active, measure a voltage representative of a current draw of the motor, wherein the motor is activated by the processing unit;
determine whether the measured voltage exceeds a predetermined runaway voltage threshold; and
in response to determining that the measured voltage exceeds the predetermined runaway voltage threshold, trigger at least a partial reset of the electronic lock, wherein the at least partial reset of the electronic lock causes the motor to deactivate.

13. The electronic lock of claim 12, wherein to trigger at least a partial reset of the electronic lock includes to reset the processing unit.

14. The electronic lock of claim 12, wherein to trigger at least a partial reset of the electronic lock includes to reset the motor.

15. The electronic lock of claim 12, wherein the runaway voltage threshold is determined based on a clutch voltage threshold, the clutch voltage threshold defining a voltage at which a clutch is configured to engage to deactivate the motor.

16. The electronic lock of claim 12, wherein the instructions, when executed by the processing unit, further cause the electronic lock to:
activate the motor to move the bolt from the locked position to the unlocked position;
measure the voltage representative of the current draw of the motor;
determine whether the measured voltage exceeds the predetermined runaway voltage threshold; and
in response to determining that the measured voltage exceeds the predetermined runaway voltage threshold, trigger at least the partial reset of the electronic lock, wherein the at least partial reset of the electronic lock causes the motor to deactivate.

17. The electronic lock of claim 12, wherein the motor runaway protection circuit includes:
a diode having a breakdown voltage; and
a transistor,
wherein at the runaway voltage threshold, the transistor connects a reset pin of the processing unit to electrical ground based on the voltage representative of the current draw of the motor exceeding the breakdown voltage of the diode.

18. An electronic lock comprising:
a latch assembly including a bolt movable between a locked position and an unlocked position;
a motor configured to move the bolt from the locked position to the unlocked position or from the unlocked position to the locked position;
a turn piece mechanically connected to the latch assembly, wherein rotation of the turn piece moves the bolt from the locked position to the unlocked position or from the unlocked position to the locked position; and
a back-drive protection circuit configured to:
measure a voltage generated by the motor during rotation of the turn piece;
determine whether the voltage exceeds a predetermined back-drive voltage threshold; and
in response to the voltage exceeding the predetermined back-drive voltage threshold, clamp the voltage.

19. The electronic lock of claim 17, wherein the back-drive voltage threshold is determined based on a voltage supplied from a battery to a motor driver.

20. The electronic lock of claim 17, wherein the back-drive protection circuit includes:
a diode; and
a transistor,
wherein the transistor is configured to activate at the back-drive voltage threshold to clamp the voltage based on a difference in a voltage at an anode side of the diode and a voltage at a source of the transistor.
